(19) United States
(12) Patent Application Publication
(10) Pub. No.: US 2017/0357787 A1
(43) Pub. Date: Dec. 14, 2017

(54) Application Code Hiding Apparatus Using Dummy Code And Method Of Hiding Application Code Using The Same

(71) Applicants: Ksign Co., Ltd., Seoul (KR); Soongsil University Research Consortium Techno- Park, Seoul (KR)

(72) Inventors: Jeong Hyun Yi, Seongnam-si (KR); Yong-Jin Park, Seoul (KR); Tae-Yong Park, Gunpo-si (KR); Sung-Eun Park, Suwon-si (KR)

(73) Assignees: Ksign Co., Ltd., Seoul (KR); Soongsil University Research Consortium Techno-Par k, Seoul (KR)

(21) Appl. No.: 15/615,027

(22) Filed: Jun. 6, 2017

(30) Foreign Application Priority Data
Jun. 8, 2016 (KR) 10-2016-0070758

(51) Int. Cl. G06F 21/14; G06F 9/45; G06F 21/60; G06F 9/44

(52) U.S. Cl. CPC G06F 21/14; G06F 21/60; G06F 8/40; G06F 2211/007; G06F 8/74

(57) ABSTRACT

An application code hiding apparatus includes a secret code dividing part, a secret code caller generating part, a code analyzing part, a dummy code generating part, a code encrypting part, a code disposing part, a code decryptor generating part, a loader generating part, a decrypted code caller generating part and an unloader generating part. The secret code dividing part divides an application code into a secret code and a normal code. The secret code caller generating part generates a secret code caller. The dummy code generating part generates a dummy code corresponding to the secret code. The code disposing part disposes the dummy code and the encrypted secret code and generates position information thereof. The code decryptor generating part generates a code decryptor. The loader generating part generates a loader. The decrypted code caller generating part generates a decrypted code caller. The unloader generating part generates an unloader.

### PRIORITY STATEMENT

This application claims priority under 35 U.S.C. §119 to Korean Patent Application No. 10-2016-0070758, filed on Jun. 8, 2016 in the Korean Intellectual Property Office (KIPO), the contents of which are herein incorporated by reference in their entireties.

### BACKGROUND

### 1. Technical Field

Exemplary embodiments relate to an application code hiding apparatus using a dummy code and a method of hiding an application code using the application code hiding apparatus. More particularly, exemplary embodiments relate to an application code hiding apparatus using a dummy code improving resistibility of reverse engineering and a method of hiding an application code using the application code hiding apparatus.

### 2. Description of the Related Art

A technique of obfuscating an application code is one of techniques for protecting software. The technique of obfuscating the application code defends forgery attack of an essential algorithm by an attacker.

A technique of packing an application code protects codes of program similarly to the technique of obfuscating the application code. By the technique of packing the application code, the packed code may not be statically analyzed.

In a conventional packing method, an original application code is entirely packed and an unpacked application code is substituted for the packed application code. Thus, the attacker may determine whether the packing method is applied to the application. In addition, the original application code, which is unpacked and loaded, is maintained until an end of the execution of the application so that the packing method may be easily disabled by a single memory dump.

### SUMMARY

Exemplary embodiments provide an application code hiding apparatus dividing an application code into a normal code and a secret code, packing only the secret code to reduce a size of packing, loading the secret code on a memory, executing the secret code and substituting a dummy code for the secret code to improve resistibility of reverse engineering.

Exemplary embodiments also provide a method of hiding an application code using the application code hiding apparatus.

In an exemplary application code hiding apparatus using a dummy code according to the present inventive concept, the application code hiding apparatus includes a secret code dividing part, a secret code caller generating part, a code analyzing part, a dummy code generating part, a code encrypting part, a code disposing part, a code decryptor generating part, a loader generating part, a decrypted code caller generating part and an unloader generating part. The secret code dividing part divides an application code into a secret code and a normal code except for the secret code. The secret code caller generating part generates a secret code caller calling the secret code. The code analyzing part analyzes the secret code. The dummy code generating part generates the dummy code corresponding to the secret code. The code encrypting part encrypts the secret code. The code disposing part disposes the dummy code and the encrypted secret code and generates position information of the dummy code and the encrypted secret code. The code decryptor generating part generates a code decryptor decrypting the encrypted secret code. The loader generating part generates a loader loading the decrypted secret code and the dummy code on a memory. The decrypted code caller generating part generates a decrypted code caller calling the decrypted secret code loaded on the memory. The unloader generating part generates an unloader unloading the dummy code and the secret code, which is executed, from the memory in an execution process of the decrypted secret code.

In an exemplary embodiment, the code analyzing part may divide the secret code into a plurality of sub secret codes.

In an exemplary embodiment, the dummy code generating part may generate a plurality of sub dummy codes corresponding to the divided sub secret codes.

In an exemplary embodiment, the code analyzing part may divide the secret code into the sub secret codes in a unit of class.

In an exemplary embodiment, the dummy code may have a signature same as a signature of the secret code. The dummy code may have an operation code different from an operation code of the secret code.

In an exemplary embodiment, the code decryptor generated by the code decryptor generating part, the loader generated by the loader generating part, the decrypted code caller generated by the decrypted code caller generating part and the unloader generated by the unloader generating part may be disposed in a native code area.

In an exemplary embodiment, the normal code and the secret code caller may be disposed in a byte code area.

In an exemplary embodiment, the encrypted secret code and the dummy code may be respectively disposed in one of the native code area, the byte code area, a resources area of an application data area and an assets area of the application data area.

In an exemplary embodiment, the encrypted secret code and the dummy code may be disposed in different areas from each other in one of the native code area, the byte code area, the resources area of the application data area and the assets area of the application data area.

In an exemplary embodiment, the code disposing part may transmit a first position of the encrypted secret code and a second position of the dummy code to the loader generating part.

In an exemplary embodiment, when the normal code is being executed, the secret code caller may call the secret code. When the secret code is called, the code decryptor may decrypt the encrypted secret code and transmit the decrypted secret code to the loader. If the dummy code exists on the memory before the decrypted secret code is loaded on the memory, the unloader may unload the dummy code from the memory. The loader may load the decrypted secret code on the memory. The decrypted code caller may execute the secret code loaded on the memory and store a result of an execution of the secret code.

In an exemplary embodiment, after the secret code is executed, the unloader may unload the secret code from the memory. The loader may load the dummy code corresponding to the secret code on the memory. The decrypted code caller may transmit the result of the execution of the secret code to the normal code.

In an exemplary method of hiding an application code according to the present inventive concept, the method includes dividing the application code into a secret code and a normal code except for the secret code, generating a secret code caller calling the secret code, analyzing the secret code, generating a dummy code corresponding to the secret code, encrypting the secret code, disposing the dummy code and the encrypted secret code and generating position information of the dummy code and the encrypted secret code, generating a code decryptor decrypting the encrypted secret code, generating a loader loading the decrypted secret code and the dummy code on a memory, generating a decrypted code caller calling the decrypted secret code loaded on the memory and generating an unloader unloading the dummy code and the secret code, which is executed, from the memory in an execution process of the decrypted secret code.

In an exemplary embodiment, the analyzing the secret code may include dividing the secret code into a plurality of sub secret codes.

In an exemplary embodiment, the generating the dummy code may include generating a plurality of sub dummy codes corresponding to the divided sub secret codes.

In an exemplary embodiment, the method may further include calling the secret code by the secret code caller when the normal code is being executed, decrypting the encrypted secret code and transmitting the decrypted secret code to the loader by the code decryptor when the secret code is called, unloading the dummy code from the memory by the unloader if the dummy code exists on the memory before the decrypted secret code is loaded on the memory, loading the decrypted secret code on the memory by the loader, executing the secret code loaded on the memory and storing a result of an execution of the secret code by the decrypted code caller.

In an exemplary embodiment, the method may further include unloading the secret code from the memory by the unloader after the secret code is executed, loading the dummy code corresponding to the secret code on the memory by the loader and transmitting the result of the execution of the secret code to the normal code by the decrypted code caller.

According to the application code hiding apparatus and the method of hiding the application code using the application code hiding apparatus, the application code is divided into the normal code and the secret code so that the size of packing of the application code is reduced. Thus, it is difficult to determine whether the application code is packed or not.

In addition, the secret code and the dummy code are hidden in various areas including the inside or the outside of the mobile apparatus so that the resistibility of static analysis may be increased.

In addition, after the secret code is loaded on the memory, the dummy code is substituted for the corresponding secret code, so that the original application code may not be easily obtained by the memory dump. Thus, the resistibility of dynamic analysis may be increased.

### BRIEF DESCRIPTION OF THE DRAWINGS

The above and other features and advantages of the present inventive concept will become more apparent by describing in detailed exemplary embodiments thereof with reference to the accompanying drawings, in which:

FIG. 1 is a block diagram illustrating an application code hiding apparatus according to an exemplary embodiment of the present inventive concept;

FIG. 2 is a conceptual diagram illustrating an operation of the application code hiding apparatus of FIG. 1;

FIG. 3 is a conceptual diagram illustrating an exemplary operation of a code disposing part of FIG. 2;

FIG. 4 is a conceptual diagram illustrating an exemplary operation of the code disposing part of FIG. 2;

FIG. 5 is a conceptual diagram illustrating a loading process and an executing process of the secret code by the application code hiding apparatus of FIG. 1; and

FIG. 6 is a conceptual diagram illustrating an unloading process of the secret code and a substituting process of the dummy code for the secret code by the application code hiding apparatus of FIG. 1.

### DETAILED DESCRIPTION OF THE EMBODIMENTS

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set fourth herein.

Rather, these exemplary embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

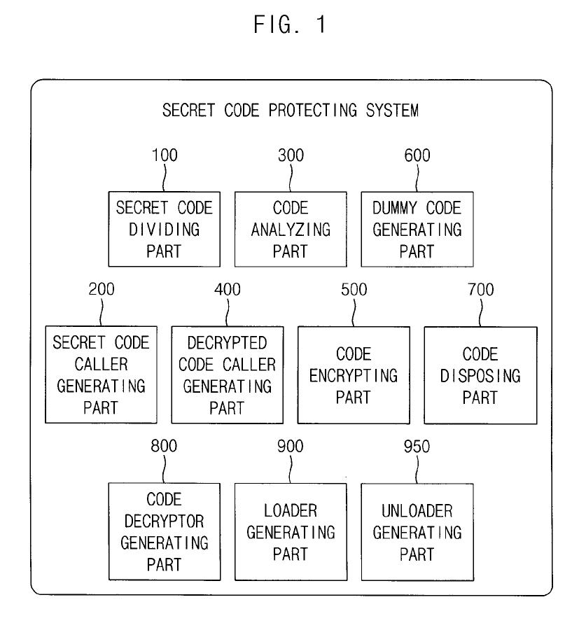

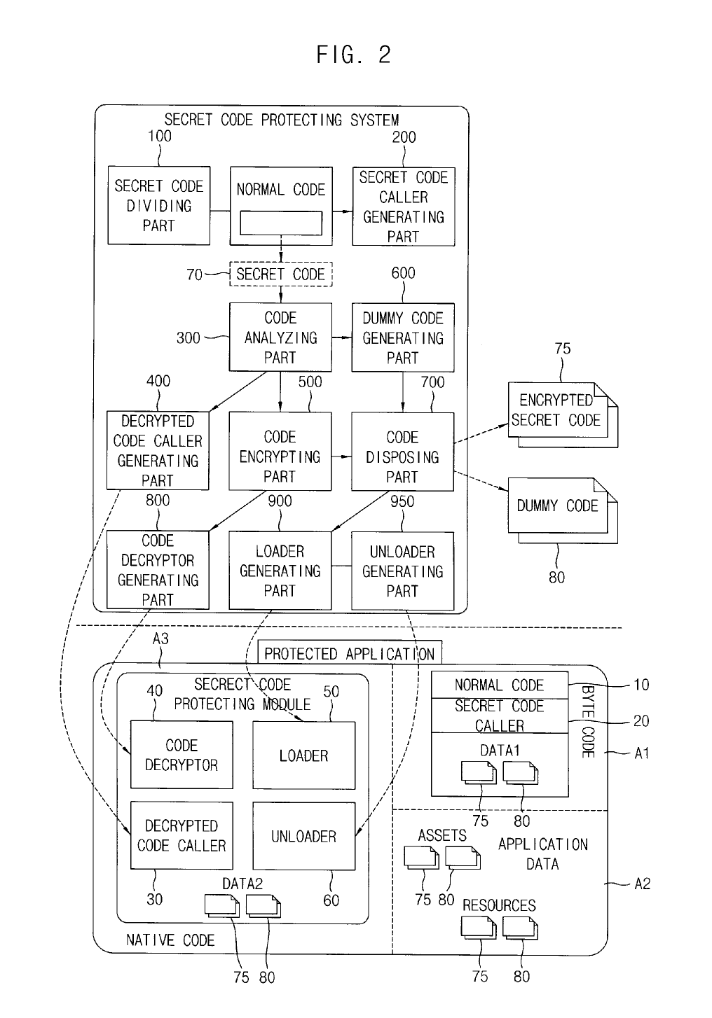

FIG. 1 is a block diagram illustrating an application code hiding apparatus according to an exemplary embodiment of the present inventive concept. FIG. 2 is a conceptual diagram illustrating an operation of the application code hiding apparatus of FIG. 1.

Referring to FIGS. 1 and 2, the application code hiding apparatus includes a secret code dividing part 100, a secret code caller generating part 200, a code analyzing part 300, a decrypted code caller generating part 400, a code encrypting part 500, a dummy code generating part 600, a code disposing part 700, a code decryptor generating part 800, a loader generating part 900 and an unloader generating part 950.

The secret code dividing part 100 divides an application code into a secret code and a normal code except for the secret code.

The secret code dividing part 100 receives the application code. The secret code dividing part 100 receives the application code having a first type. For example, the first type may be a byte code. For example, the application code may be a Java code. For example, the application code may be a Dalvik executable (.dex) code.

The secret code dividing part 100 divides the application code into the secret code 70 and the normal code 10 except for the secret code 70. For example, the secret code 70 may mean the code required to be protected from forgery attack of the application. The normal code 10 is disposed in a byte code area A1.

The secret code caller generating part 200 generates a secret code caller 20 to call the secret code 70.

For example, the secret code caller 20 may call the secret code 70 using a signature of the secret code 70. For example, the signature of the secret code 70 may be a parameter of a function.

For example, when the parameter used to call function A which is the secret code 70 is (integer, integer), the signature of the secret code 70 may be generated based on the parameter of (integer, integer). For example, when the parameter used to call function B which is the secret code 70 is (text, text, integer), the signature of the secret code 70 may be generated based on the parameter of (text, text, integer). Alternatively, the signature of the secret code 70 may be generated based on other information not based on the parameter of the function.

The secret code caller 20 generated by the secret code caller generating part 200 is disposed in the byte code area A1. The secret code caller 20 calls the secret code 70 loaded on a memory using the signature of the secret code 70.

The code analyzing part 300 analyzes the secret code 70. The code analyzing part 300 analyzes the secret code 70 to determine a method of protecting the secret code 70.

The code analyzing part 300 may output the method of protecting the secret code 70 to the decrypted code caller generating part 400, the code encrypting part 500 and the dummy code generating part 600.

The dummy code generating part 600 generates the dummy code 80 corresponding to the secret code 70. When the dummy code 80 is substituted for the secret code 70 and the application is executed, the dummy code 80 does not cause an error.

For example, the dummy code 80 may have a signature same as the signature of the secret code 70. The dummy code 80 may have an operation code different from the operation code of the secret code 70. If the dummy code 80 has the signature same as the signature of the secret code 70 and the operation code different from the operation code of the secret code 70, the attacker may misperceive that the secret code 70 is analyzed although the dummy code 80 is analyzed. Thus, the analysis of the secret code 70 by the attacker may be interrupted and delayed.

Alternatively, the dummy code 80 may have the signature different from the signature of the secret code 70.

For example, the code analyzing part 300 may divide the secret code 70 into a plurality of sub secret codes. For example, the code analyzing part 300 may divide the secret code 70 into the plurality of sub secret codes in a unit of a class. For example, the code analyzing part 300 may divide the secret code 70 into the plurality of sub secret codes in a unit of a function.

The dummy code generating part 600 may generate a plurality of sub dummy codes corresponding to the plurality of sub secret codes. For example, the number of the sub dummy codes may be same as the number of the sub secret codes.

When the code analyzing part 300 divides the secret code 70 into the sub secret codes in a unit of the class or the function, the size of the packing is reduced, the size of the code loaded on the memory is also reduced and the loading and unloading of the sub secret codes are repeated in the small unit so that the dynamic reversing of the application code may be more difficult.

The code encrypting part 500 receives the method of protecting the secret code 70 from the code analyzing part 300. The code encrypting part 500 encrypts the secret code 70. Due to the encryption of the secret code 70, the resistibility of static analysis may be increased.

The code disposing part 700 receives the dummy code 80 from the dummy code generating part 600 and receives the encrypted secret code 75 from the code encrypting part 500.

The code disposing part 700 disposes the dummy code 80 and the encrypted secret code 75. The code disposing part 700 generates position information of the dummy code 80 and the encrypted secret code 75.

The code disposing part 700 outputs the position information of the dummy code 80 and the encrypted secret code 75 to the loader generating part 900. For example, the code disposing part 700 outputs a first position of the encrypted secret code 75 and a second position of the dummy code 80 to the loader generating part 900.

The code decryptor generating part 800 receives encrypting information of the secret code 70 of the code encrypting part 500. The code decryptor generating part 800 generates a code decryptor to decrypt the encrypted secret code 75.

The loader generating part 900 receives the first position of the encrypted secret code 75 and the second position of the dummy code 80 from the code disposing part 700. The loader generating part 900 generates a loader 50 loading the decrypted secret code 70 and the dummy code 80 on the memory. The loader 50 may load the decrypted secret code 70 and the dummy code 80 on the memory based on the first position and the second position received from the code disposing part 700.

The decrypted code caller generating part 400 generates a decrypted code caller 30 calling the decrypted secret code 70 loaded on the memory.

The unloader generating part 950 generates unloader 60 unloading the dummy code 80 and the executed secret code 70 from the memory in the executing process of the decrypted secret code 70.

For example, the normal code 10 and the secret code caller 20 may be disposed in the byte code area A1.

For example, the code decryptor 40 generated by the code decryptor generating part 800, the loader 50 generated by the loader generating part 900, the decrypted code caller 30 generated by the decrypted code caller generating part 400 and the unloader 60 generated by the unloader generating part 950 may be disposed in a native code area A3.

When the application code is inputted to the application code hiding apparatus, the secret code dividing part 100 divides the application code into the normal code 10 and the secret code 70. The secret code caller generating part 200 generates a module to call the divided secret code 70.

The divided secret code 70 is inputted to the code analyzing part 300. The secret code 70 passes through the code analyzing part 300, the code encrypting part 500 and the dummy code generating part 600. As a result, the encrypted secret code 75 and the dummy code 80 are generated.

The code disposing part 700 may dispose the encrypted secret code 75 and the dummy code 80 in various positions. For example, the encrypted secret code 75 and the dummy code 80 may be disposed in a first data area DATA1 of the byte code area A1. For example, the encrypted secret code 75 and the dummy code 80 may be disposed in an assets folder of an application data area A2. For example, the encrypted secret code 75 and the dummy code 80 may be disposed in a resources folder of the application data area A2. For example, the encrypted secret code 75 and the dummy code 80 may be disposed in a second data area DATA2 of the native code area A3.

The encrypted secret code 75 and the dummy code 80 may be disposed in the same area. Alternatively, the encrypted secret code 75 and the dummy code 80 may be disposed in the areas different from each other.

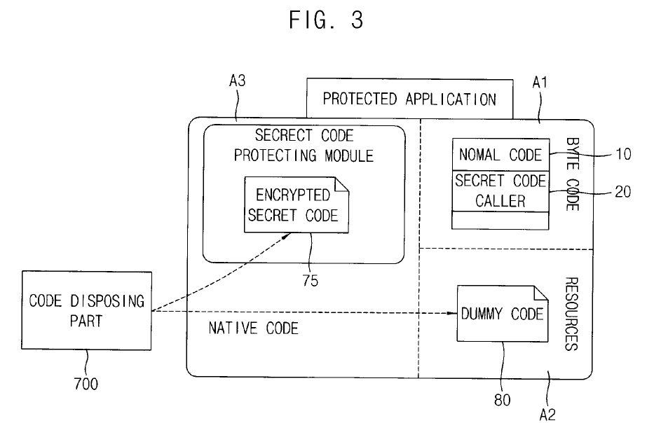

FIG. 3 is a conceptual diagram illustrating an exemplary operation of the code disposing part 700 of FIG. 2.

Referring to FIG. 3, the encrypted secret code 75 and the dummy code 80 may be disposed in the areas different from each other.

The code disposing part 700 disposes the encrypted secret code 75 in the native code area A3 and the dummy code 80 corresponding to the encrypted secret code 75 in the assets folder of the application data area.

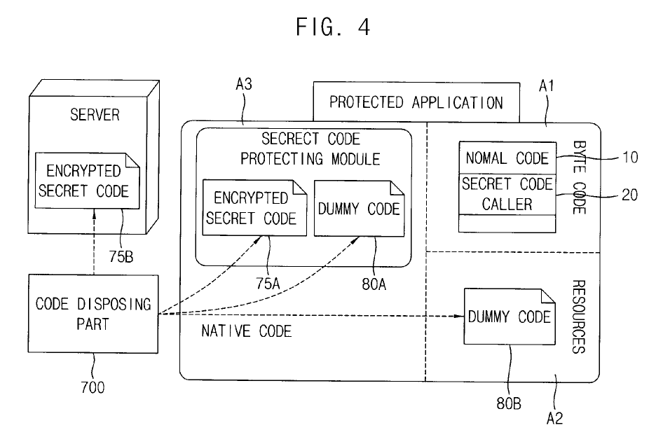

FIG. 4 is a conceptual diagram illustrating an exemplary operation of the code disposing part 700 of FIG. 2.

Referring to FIG. 4, the encrypted secret code 75A and 75B and the dummy code 80A and 80B may be disposed in the same area or in the areas different from each other.

The code disposing part 700 disposes a first secret code 75A and a first dummy code 80A corresponding to the first secret code 75A in the same area. The code disposing part 700 disposes the first secret code 75A and the first dummy code 80A in the native code area A3.

The code disposing part 700 disposes a second secret code 75B and a second dummy code 80B corresponding to the second secret code 75B in the areas different from each other. The code disposing part 700 disposes the second secret code 75B in an external server and the second dummy code 80A in the resources folder of the application data area.

As explained above, the code disposing part 700 may hide the encrypted secret code and the corresponding dummy code in the various areas in the mobile apparatus or an external apparatus capable of communicating with the mobile apparatus.

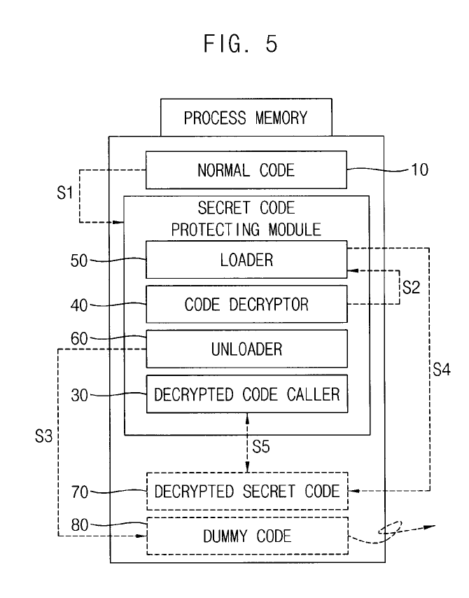

FIG. 5 is a conceptual diagram illustrating a loading process and an executing process of the secret code 70 by the application code hiding apparatus of FIG. 1.

Referring to FIGS. 1 to 5, when the normal code 10 is being executed, the secret code caller 20 calls the secret code 70 (step S1).

When the secret code 70 is called, the code decryptor 40 decrypts the encrypted secret code 75 and transmits the decrypted secret code 70 to the loader 50 (step S2).

If the dummy code 80 exists on the memory before the decrypted secret code 70 is loaded on the memory, the unloader 60 unloads the dummy code 80 from the memory (step S3). If the dummy code 80 does not exist on the memory before the decrypted secret code 70 is loaded on the memory, the unloader 60 may not be operated.

The loader 50 loads the decrypted secret code 70 on the memory (step S4).

The decrypted code caller 30 executes the secret code 70 loaded on the memory and stores the result of the execution of the secret code 70 (step S5).

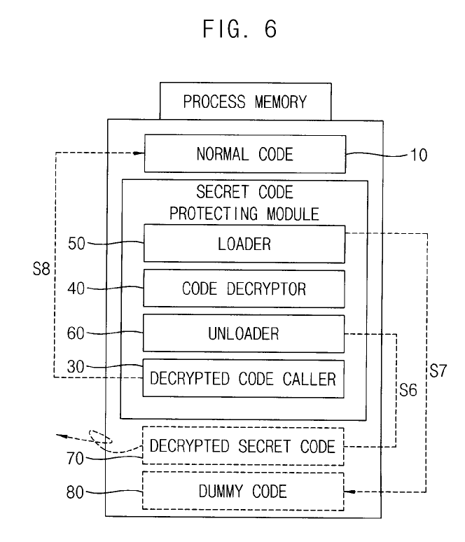

FIG. 6 is a conceptual diagram illustrating an unloading process of the secret code 70 and a substituting process of the dummy code 80 for the secret code 70 by the application code hiding apparatus of FIG. 1.

Referring to FIGS. 1 to 6, after the secret code 70 is executed, the unloader 60 unloads the secret code 70 from the memory (step S6).

The loader 50 loads the dummy code 80 corresponding to the secret code 70 on the memory (step S7).

The decrypted code caller 30 transmits the result of the execution of the secret code 70 to the normal code 10 (step S8).

According to the present exemplary embodiment, the packing and unpacking processes are operated in a unit of the secret code or the sub secret code instead of the entire execution code so that it is difficult to determine whether the application code is packed or not.

In addition, the secret code and the dummy code are hidden in various areas in the mobile apparatus or an external apparatus capable of communicating with the mobile apparatus so that the resistibility of static analysis may be increased.

In addition, after the secret code or the sub secret code is executed, the dummy code or the sub dummy code corresponding to the secret code or the sub secret code is substituted for the secret code or the sub secret code so that the original application code may not be easily obtained by the memory dump. Thus, the resistibility of dynamic analysis may be increased.

The present inventive concept may be employed to any electric devices operating application code hiding. The electric devices may be one of a cellular phone, a smart phone, a laptop computer, a tablet computer, a digital broadcasting terminal, a PDA, a PMP, a navigation device, a digital camera, a camcorder, a digital television, a set top box, a music player, a portable game console, a smart card, a printer, etc.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. An application code hiding apparatus using a dummy code comprising:
a secret code dividing part dividing an application code into a secret code and a normal code except for the secret code;
a secret code caller generating part generating a secret code caller calling the secret code;
a code analyzing part analyzing the secret code;
a dummy code generating part generating the dummy code corresponding to the secret code;
a code encrypting part encrypting the secret code;
a code disposing part disposing the dummy code and the encrypted secret code and generating position information of the dummy code and the encrypted secret code;
a code decryptor generating part generating a code decryptor decrypting the encrypted secret code;
a loader generating part generating a loader loading the decrypted secret code and the dummy code on a memory;
a decrypted code caller generating part generating a decrypted code caller calling the decrypted secret code loaded on the memory; and
an unloader generating part generating an unloader unloading the dummy code and the secret code, which is executed, from the memory in an execution process of the decrypted secret code.

2. The application code hiding apparatus of claim 1, wherein the code analyzing part divides the secret code into a plurality of sub secret codes.

3. The application code hiding apparatus of claim 2, wherein the dummy code generating part generates a plurality of sub dummy codes corresponding to the divided sub secret codes.

4. The application code hiding apparatus of claim 2, wherein the code analyzing part divides the secret code into the sub secret codes in a unit of class.

5. The application code hiding apparatus of claim 1, wherein the dummy code has a signature same as a signature of the secret code, and
the dummy code has an operation code different from an operation code of the secret code.

6. The application code hiding apparatus of claim 1, wherein the code decryptor generated by the code decryptor generating part, the loader generated by the loader generating part, the decrypted code caller generated by the decrypted code caller generating part and the unloader generated by the unloader generating part are disposed in a native code area.

7. The application code hiding apparatus of claim 6, wherein the normal code and the secret code caller are disposed in a byte code area.

8. The application code hiding apparatus of claim 7, wherein the encrypted secret code and the dummy code are respectively disposed in one of the native code area, the byte code area, a resources area of an application data area and an assets area of the application data area.

9. The application code hiding apparatus of claim 8, wherein the encrypted secret code and the dummy code are disposed in different areas from each other in one of the native code area, the byte code area, the resources area of the application data area and the assets area of the application data area.

10. The application code hiding apparatus of claim 7, wherein the code disposing part transmits a first position of the encrypted secret code and a second position of the dummy code to the loader generating part.

11. The application code hiding apparatus of claim 1, wherein when the normal code is being executed, the secret code caller calls the secret code,
when the secret code is called, the code decryptor decrypts the encrypted secret code and transmits the decrypted secret code to the loader,
if the dummy code exists on the memory before the decrypted secret code is loaded on the memory, the unloader unloads the dummy code from the memory,
the loader loads the decrypted secret code on the memory, and
the decrypted code caller executes the secret code loaded on the memory and stores a result of an execution of the secret code.

12. The application code hiding apparatus of claim 11, wherein after the secret code is executed, the unloader unloads the secret code from the memory,
the loader loads the dummy code corresponding to the secret code on the memory, and
the decrypted code caller transmits the result of the execution of the secret code to the normal code.

13. A method of hiding an application code, the method comprising:
dividing the application code into a secret code and a normal code except for the secret code;
generating a secret code caller calling the secret code;
analyzing the secret code;
generating a dummy code corresponding to the secret code;
encrypting the secret code;
disposing the dummy code and the encrypted secret code and generating position information of the dummy code and the encrypted secret code;
generating a code decryptor decrypting the encrypted secret code;
generating a loader loading the decrypted secret code and the dummy code on a memory;
generating a decrypted code caller calling the decrypted secret code loaded on the memory; and
generating an unloader unloading the dummy code and the secret code, which is executed, from the memory in an execution process of the decrypted secret code.

14. The method of claim 13, wherein the analyzing the secret code comprises dividing the secret code into a plurality of sub secret codes.

15. The method of claim 14, wherein the generating the dummy code comprises generating a plurality of sub dummy codes corresponding to the divided sub secret codes.

16. The method of claim 13, further comprising:
calling the secret code by the secret code caller when the normal code is being executed;
decrypting the encrypted secret code and transmitting the decrypted secret code to the loader by the code decryptor when the secret code is called;
unloading the dummy code from the memory by the unloader if the dummy code exists on the memory before the decrypted secret code is loaded on the memory;
loading the decrypted secret code on the memory by the loader; and
executing the secret code loaded on the memory and storing a result of an execution of the secret code by the decrypted code caller.

17. The method of claim 16, further comprising:
unloading the secret code from the memory by the unloader after the secret code is executed;
loading the dummy code corresponding to the secret code on the memory by the loader; and
transmitting the result of the execution of the secret code to the normal code by the decrypted code caller.
